(19) United States
(12) Patent Application Publication
(10) Pub. No.: US 2009/0298367 A1
(43) Pub. Date: Dec. 3, 2009

(54) Fibrous Support Comprising A Silicone Coating

(75) Inventors: Francis Lafaysse, Lyon (FR); Laurent Dumont, Messimy (FR); Bertrand Bordes, Lyon (FR)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: RHODIA RECHERCHE ET TECHNOLOGIES, Aubervillers (FR)

(21) Appl. No.: 12/097,949

(22) PCT Filed: Dec. 15, 2006
(86) PCT No.: PCT/EP2006/069789

§ 371 Date: Jun. 5, 2009

(30) Foreign Application Priority Data
Dec. 19, 2005 (FR) 0512886

(51) Int. Cl. B32B 5/16; B05D 3/02; B05D 3/06

(52) U.S. Cl. 442/59; 428/323; 427/387; 427/595

(57) ABSTRACT

The present invention relates to an article comprising at least one fibrous support surface coated by at least two successive layers of silicone type.

The present invention relates to a fibrous support comprising a silicone coating, made up of at least two successive layers of silicone type. The first layer, that in contact with the fibrous support, is a layer based on a silicone elastomer composition. The second layer, that in contact with the first layer, is a thin layer obtained by crosslinking an aqueous emulsion of a polyorganosiloxane that can be crosslinked by polyaddition reaction comprising a high level of fillers. The invention also relates to a process for manufacturing such coated fibrous supports, especially airbags.

### PRIOR ART

The general field of the invention is that of the use of silicone compositions, in particular those of the two-component or multicomponent type, that can be crosslinked by polyaddition reactions to produce an elastomer in a thin film as a coating for various fibrous supports, such as, for example, woven, knitted or nonwoven fibrous supports.

Such silicone coatings are generally obtained by coating the fibrous supports then by curing, which proceeds from the polyaddition of the unsaturated (alkenyl, e.g. Si-Vi) groups of a polyorganosiloxane to the hydrogens of the same or of another polyorgano-siloxane.

There is, for many fibrous supports such as, in particular, in the field of airbags, flexible sealing sleeves, clothing or architectural fabrics, a need to confer on the latter, via a silicone coating, both sealing properties and a low friction coefficient so that the surface of the support is not rough and abrasive to the touch. Also added to these properties is the need to obtain a silicone coating having the other properties required, as regards the mechanical properties, such as cohesion, flexibility, suppleness, resistance to fraying, tear strength, and also creasability.

In these applications it is often difficult to obtain a good compromise between these properties.

Currently, many motor vehicles are equipped with an acceleration sensor which measures the decelerations of the vehicle. When the reference value of the deceleration is exceeded, an explosive pellet initiates the combustion of a complementary charge, then that of the solid fuel; this solid fuel is converted to a gas and inflates the cushion. For more details on these individual airbags or inflatable cushions, reference may especially be made to French Patent FR-A-2 668 106.

The latter are generally formed from a cloth of synthetic fiber, for example of polyamide, covered on at least one of its faces by a layer of a silicone composition. These silicone compositions have therefore found a significant outlet in the coating of flexible—woven, knitted or nonwoven—materials used for manufacturing individual airbags for vehicle occupants.

Front airbags may be adaptative and may be deployed in proportion to the violence of the impact. The protection system is now increasingly completed by side airbags, or curtains. For this type of airbags, it is important that the airbags remain inflated as long as possible, especially when the motor vehicle undergoes an impact that causes it to undergo a series of rollovers. It is therefore important that these airbags are perfectly gastight from this point of view.

To increase the gastightness of airbags it is possible to use a particular technique for weaving the airbags, a one-piece woven technique, such as is described in Applications GB 2383304 and GB 2397805.

The airbag obtained is then covered, on its outer surface, with a large enough amount of silicone composition so as to ensure good airtightness.

However, the application of such an amount of a silicone composition to the surface of the airbags leads to a rough and abrasive surface being obtained that has a “tacky” feel and a high friction coefficient. Such a surface poses many problems during folding of the airbag, then during its inflation, leading to a difficulty in deploying or a preferential orientation that is not desired during the deployment, an excessive friction with the components of the motor vehicle, such as the glass of the side windows, and also risks of injuries for the passenger whose head or limbs rub against the deployed airbag.

It is therefore necessary to develop a silicone coating, which makes it possible to provide the fibrous supports, especially for airbags, with the necessary gastightness, which is not rough and abrasive and that has a softer feel and a low friction coefficient.

### INVENTION

The Applicant has brought to light a silicone coating composed of two successive layers for fibrous supports that overcomes the aforementioned drawbacks.

The present invention thus relates to a surface of a fibrous support, such as airbags, comprising two successive layers of silicone type. The first layer, that in contact with the fibrous support, is a layer based on a silicone elastomer composition. The second layer, that in contact with the first layer, is a thin layer obtained by crosslinking an aqueous emulsion of a polyorganosiloxane that can be crosslinked by polyaddition reaction comprising a high level of fillers.

The silicone coating obtained is suitable for conferring excellent mechanical qualities on the fibrous supports, such as cohesion, flexibility, suppleness, resistance to fraying, tear strength and combing strength, and also creasability, while obtaining an excellent compromise with regard to the gastightness, especially airtightness, properties and abrasion resistance properties (scrub test) and friction coefficient properties representative of a low friction coefficient. The solution of the invention furthermore makes it possible to obtain fibrous supports that also have the other expected and required properties such as good fire resistance and temperature resistance.

Owing to the properties and characteristics indicated above, it is possible to produce individual airbags for the occupants of a vehicle from open-weave fabrics as described above, in particular polyamide or polyester fabrics, which once coated have a good friction coefficient and good combing strength and tear strength, furthermore possessing optimal properties, especially impermeability, heat protection, porosity, foldability and fire resistance properties. This makes it possible to produce higher-performing and less expensive airbags than the airbags produced from the coated fabrics of the prior art.

The solution according to the invention also allows a better control of the desired thickness of silicone coating on the fibrous support, thus guaranteeing the best performances possible as regards impermeability and touch characteristics.

### DETAILED SUMMARY OF THE INVENTION

The present invention thus relates to an article comprising at least one fibrous support surface coated by at least two successive layers of silicone type:
an inner layer (1), in contact with the fibrous support, based on a silicone elastomer composition; and
an outer layer (2), having a surface density between 1 and 20 g/m², in contact with the inner layer (1), obtained by crosslinking an aqueous emulsion of a polyorganosiloxane that can be crosslinked by polyaddition reaction, comprising:
   (A) at least one polyorganosiloxane (POS) having, per molecule, at least two unsaturated functional groups of C₂-C₆ alkenyl type, bonded to the silicon;
   (B) at least one polyorganosiloxane (POS) having, per molecule, at least two, sometimes three, hydrogen atoms bonded to the silicon;
   (C) at least one surfactant;
   (D) at least one crosslinking catalyst;
   (E) at least 10 to 80 wt % of a filler, relative to the dry weight of the outer layer after crosslinking, said filler has a d₅₀ particle size between 0.5 and 50 μm; and
   (F) water;
   (G) optionally at least one polyorganosiloxane (POS) resin optionally comprising at least one, preferably at least two, alkenyl group(s);
   (H) optionally at least one crosslinking inhibitor;
   (I) optionally at least one adhesion promoter; and
   (J) optionally at least one formulation additive.

The present invention targets any product capable of being obtained by deposition onto a fibrous support of the aforementioned silicone layers. As examples, mention may be made of the airbags used for protecting the occupants of a vehicle, glass braids, such as the fiberglass sheaths for thermal and dielectric protection for electrical wires, conveyor belts, fire-resistant fabrics, thermal insulation, compensators, such as flexible sealing sleeves for pipework, clothing or else flexible materials intended to be used in interior or exterior textile architecture, such as tarpaulins, tents, stands and marquees.

The fibrous supports intended to be coated may be, for example, woven, nonwoven or knit fabrics or more generally any fibrous support comprising fibers and/or fibers chosen from the group of materials comprising: glass, silica, metals, ceramic, silicon carbide, carbon, boron, natural fibers such as cotton, wool, hemp, linen, artificial fibers such as viscose, or cellulose fibers, synthetic fibers such as polyesters, polyamides, polyacrylics, chlorofibers, polyolefins, polyimides, synthetic rubbers, polyvinyl alcohol, aramids, fluorofibers, phenolics, etc.

The airbags preferably used within the context of the invention are one-piece woven airbags, such as mentioned in Applications GB 2383304 and GB 2397805. These airbags may be based on various fibrous materials, such as for example polyamides or polyesters.

The polyorganosiloxanes (POSs), main constituents of the compositions according to the invention, may be linear, branched or crosslinked, and may comprise hydrocarbon-based radicals and reactive groups such as, for example, alkenyl groups and/or hydrogen atoms. Organopolysiloxane compositions are amply described in the literature and especially in the work by Walter Noll “Chemistry and Technology of Silicones”, Academic Press, 1968, 2^{nd} Edition, pages 386 to 409.

It is possible to use a wide variety of two-component or one-component organopolysiloxane compositions that crosslink at ambient temperature or at high temperature via polyaddition reactions, mainly by reaction of hydrosilyl groups with alkenylsilyl groups, generally in the presence of a metallic catalyst, preferably a platinum catalyst. These compositions are described, for example, in U.S. Pat. Nos. 3,220,972, 3,284,406, 3,436,366, 3,697,473 and 4,340,709.

The organopolysiloxanes incorporated into these compositions are generally made up of pairs based, on the one hand, on at least one linear, branched or crosslinked polysiloxane comprising at least two alkenyl groups and, on the other hand, at least one linear, branched or crosslinked hydropolysiloxane comprising at least two, sometimes at least three, hydrogen atoms.

The polyorganosiloxanes (A) that can be crosslinked by polyaddition may have units, especially at least two units, of formula (I) and optionally at least some of the other units are units of average formula (II):

WₐY_{b}SiO_{(4-(a+b))/2} (I)

Y_{c}SiO_{(4-c)/2} (II)

in which formulae:
W is an alkenyl, preferably vinyl or allyl, group;
the symbols Y, which are identical or different, represent:
a linear or branched alkyl radical containing 1 to 20 carbon atoms, optionally substituted by at least one halogen, preferably fluorine, the alkyl radicals preferably being methyl, ethyl, propyl, octyl and 3,3,3-trifluoropropyl;
an optionally substituted cycloalkyl radical containing between 5 and 8 cyclic carbon atoms;
an optionally substituted aryl radical containing between 6 and 12 carbon atoms; and/or
an aralkyl part having an alkyl part containing between 5 and 14 carbon atoms and an aryl part containing between 6 and 12 carbon atoms, optionally substituted on the aryl part by halogens and/or alkyls;
a is 1 or 2, preferably equal to 1, b is 0, 1 or 2 and a+b=1, 2 or 3; and
c=0, 1, 2 or 3.

The polyorganosiloxane compounds (B) may have units, at least two or at least three depending on the case, of formula (III) and optionally at least some of the other units are units of average formula (IV):

HY_{c}SiO_{(3-c)/2} (III)

Y_{g}SiO_{(4-g)/2} (IV)

in which:
H represents a hydrogen atom;
the symbols Y, which are identical or different, are as defined previously;
c=0, 1 or 2; and
g=0, 1, 2 or 3.

By way of illustration, mention may be made of the organic radicals Y, directly bonded to the silicon atoms: methyl; ethyl; propyl; isopropyl; butyl; isobutyl; n-pentyl; t-butyl chloromethyl; dichloro-methyl; α-chloroethyl; α,β-dichloroethyl; fluoromethyl; difluoromethyl α,β-difluoroethyl; 3,3,3-trifluoropropyl trifluorocyclopropyl; 4,4,4-trifluorobutyl; 3,3,4,4,5,5-hexafluoropentyl; β-cyanoethyl; β-cyano-propyl; phenyl; p-chlorophenyl; m-chlorophenyl; 3,5-dichlorophenyl; trichlorophenyltetrachlorophenyl o-, p- or m-tolyl; α,α,α-trifluorotolyl; or xylyl groups such as 2,3-dimethylphenyl or 3,4-dimethylphenyl groups.

Preferably, the organic radicals Y bonded to the silicon atoms are methyl or phenyl radicals, these radicals possibly optionally being halogenated or else cyanoalkyl radicals.

In particular, a POS (A) corresponding to a polydimethylsiloxane oil terminated at each of the chain ends by a (CH₃)₂ViSiO_{1/2} unit (M^{Vi}) is preferred.

In particular, a POS (B) corresponding to a poly(dimethyl)(hydromethyl) siloxane oil terminated at each of the chain ends by a (CH₃)₂HSiO_{1/2} unit (MH^{H}) is preferred.

The emulsions according to the invention may additionally comprise at least one silicone resin (G) of a polyorganosiloxane (POS) resin type optionally comprising at least one, preferably at least two, alkenyl, especially non-hydroxylated, group(s). This resin may especially correspond to the aforementioned definition of the polyorganosiloxanes (A).

These silicone resins are branched POS polymers that are well known and are commercially available. They have, per molecule, at least two different units chosen from those of formula R¹₃SiO_{1/2} (M unit), R¹₂SiO_{2/2} (D unit), R¹SiO_{3/2} (T unit) and SiO_{4/2} (Q unit).

The radicals R¹ are identical or different and are chosen from linear or branched alkyl radicals, vinyl, phenyl and/or 3,3,3-trifluoropropyl radicals. Preferably, the alkyl radicals have from 1 to 6 carbon atoms inclusive. More particularly, mention may be made, as alkyl radicals R¹, of methyl, ethyl, isopropyl, tert-butyl and n-hexyl radicals.

Advantageously, in the polyaddition type emulsions, at least some of the radicals R¹ are vinyl residues, with a weight content of Vi in particular between 0.1 and 2%. These vinyl functions are borne by the M, D or T units. As an example, mention may be made of the vinyl MDQ resins, such as MD^{Vi}Q, or else MM^{Vi}Q resins (D^{Vi} is represented by the formula (R¹₂SiO_{2/2} for which one radical R¹ corresponds to a vinyl residue; M^{Vi} is represented by the formula R¹₃SiO_{1/2} for which one radical R¹ corresponds to a vinyl residue).

In particular, a resin (G) corresponding to an MD^{Vi}Q resin, optionally in solution in a polydimethylsiloxane oil terminated at each of the chain ends by a (CH₃)₂ViSiO_{1/2} unit, is preferred.

The POS (A) will have a dynamic viscosity at least equal to 200 mPa·s and preferably less than 500 000 mPa·s, preferably between 3500 and 100 000 mPa·s.

The POS (B) may have a dynamic viscosity in particular of less than 300 mPa·s, preferably between 1 and 50 mPa·s.

The POS resin (G) may have a dynamic viscosity between 200 and 500 000 mPa·s, preferably between 3000 and 100 000 mPa·s.

All the viscosities in question in the present document correspond to a dynamic viscosity value which is measured, in a manner that is known per se, at 25° C., with a Brookfield type device.

Regarding the surfactants (C), they may be anionic, cationic or nonionic. In particular, they may be one or more polyethoxylated fatty alcohols. Preferably, the surfactants are nonionic. The role of the surfactant will especially be to refine the particle size distribution of the emulsion, optionally to improve its stability, and also to ensure its wetting on the first silicone layer.

The nonionic surfactants may be chosen from alkoxylated fatty acids, polyvinyl alcohols, polyalkoxylated alkylphenols, polyalkoxylated fatty alcohols, polyalkoxylated or polyglycerolated fatty amides, polyglycerolated alcohols and α-diols, ethylene oxide/propylene oxide block polymers and also alkyl glucosides, alkyl polyglucosides, sucrose ethers, sucrose esters, sucroglycerides, sorbitan esters, and ethoxylated compounds of these sugar derivatives. They advantageously have a HLB of at least 10.

The anionic surfactants may be chosen from alkylbenzene sulfonates, alkyl sulfates, alkyl ether sulfates, alkyl aryl ether sulfates, dialkyl sulfosuccinates, alkyl phosphates and ether phosphates, of alkali metals. They advantageously have a HLB of at least 10.

Among the cationic surfactants, mention may be made of aliphatic or aromatic fatty amines, aliphatic fatty amides, and quaternary ammonium derivatives. They advantageously have a HLB of at least 10.

The surfactant, used alone or as a mixture, is especially chosen as a function of the nature of the POSs used. An alkylsiloxane modified by a polyalkylene oxide is particularly useful within the context of the invention.

As a crosslinking catalyst, it is especially possible to choose a catalyst consisting of at least one metal, or compound, from the platinum group which are also well known. The platinum group metals are those known under the name of platinoids, a term that encompasses, besides platinum, ruthenium, rhodium, palladium, osmium and iridium. Preferably, platinum and rhodium compounds are used. It is possible, in particular, to use the complexes of platinum and of an organic product described in U.S. Pat. No. 3,159,601, U.S. Pat. No. 3,159,602, U.S. Pat. No. 3,220,972 and European Patents EP-A-0 057 459, EP-A-0 188 978 and EP-A-0 190 530, the (Karstedt) complexes of platinum and of vinylorganosiloxanes described in U.S. Pat. No. 3,419,593, U.S. Pat. No. 3,715,334, U.S. Pat. No. 3,377,432 and U.S. Pat. No. 3,814,730. The catalyst generally preferred is platinum. In this case, the weight amount of catalyst (III), calculated by weight of platinum metal, is generally between 2 and 400 ppm, preferably between 5 and 200 ppm based on the total weight of the polyorganosiloxanes (I) and (II).

As explained previously, the emulsion comprises from 10 to 80 wt % of a filler, relative to the dry weight of the outer layer after crosslinking, said filler has a d₅₀ particle size between 0.5 and 50 μm, preferably between 1 and 10 μm. This d₅₀ particle size corresponds to the particle size under which 50% of the distribution by weight are found.

The emulsion according to the invention may especially comprise two types of fillers (E) having different particle size distributions. For example, one type of filler (E) may have a particle size distribution between 0.5 and 5 μm and another type of filler (E) may have a particle size distribution between 10 and 50 μm.

As fillers of this type, mention may especially be made of the fillers included in the group comprising: silicas, calcium carbonate, ground quartz, calcined clays, diatomaceous earths, carbon black, titanium dioxide, aluminum oxide, hydrated alumina, expanded vermiculite, unexpanded vermiculite, zinc oxide, mica, talc, iron oxide, barium sulfate and flaked lime. These fillers may be incorporated as they are or may be surface treated. These fillers may optionally be in the form of an aqueous dispersion (slurry).

It is generally possible to use from 20 to 60 wt %, preferably from 30 to 50 wt % of fillers (E) relative to the dry weight of the outer layer after crosslinking (i.e. silicone phase).

As crosslinking inhibitor (H), it is possible to use those conventionally employed in POS crosslinking reactions. They may especially be chosen from the following compounds:
polyorganosiloxanes substituted by at least one alkenyl which may optionally be present in cyclic form, tetramethylvinyltetrasiloxane being particularly preferred;
pyridine;
organic phosphines and phosphites;
unsaturated amides;
alkylated maleates; and
acetylenic alcohols.

As acetylenic alcohols (cf. FR-B-1 528 464 and FR-A-2 372 874), which are among the preferred thermal blockers for the hydrosilylation reaction, it is especially possible to choose 1-ethenyl-1-cyclohexanol, 3-methyl-1-dodecen-3-ol, 3,7,11-trimethyl-1-dodecen-3-ol, 1,1-diphenyl-2-propyn-1-ol, 3-ethyl-6-ethyl-1-nonyn-3-ol, 2-methyl-3-butyn-2-ol, 3-methyl-1-penta-decyn-3-ol, diallyl maleate or derivatives of diallyl maleate.

Such an inhibitor may be present in an amount of at most 3000 ppm, preferably in an amount of 100 to 1000 ppm relative to the total weight of the organopolysiloxanes (I) and (II).

It is optionally possible to use any adhesion promoter (I) commonly used in the field. For example, use could be made of:
a vinyl-based silane or organosiloxane alone or partially hydrolyzed and also one of its reaction products;
a silane or organosiloxane functionalized by an epoxy functional group alone or partially hydrolyzed and also one of its reaction products;
an amino-functional silane or organosiloxane alone or partially hydrolyzed and also one of its reaction products;
a silane or organosiloxane functionalized by an anhydride radical alone or partially hydrolyzed and also one of its reaction products; and/or
a butyl titanate type chelate.

In particular, this adhesion promoter could be chosen from:
at least one protective hydrocolloid, preferably polyvinyl alcohol, which may also act as a surfactant possibly in combination with other emulsifiers;
specific silanes or polyorganosiloxanes, namely which are hydroxylated and amino-salified; or else
a protective hydrocolloid, preferably polyvinyl alcohol, and hydroxylated and amino-salified silanes and/or polyorganosiloxanes.

The emulsion according to the invention may also comprise other conventional formulation additives (J), such as condensation catalysts, colorants, flame retardants, bactericides, mineral or organic pigments, organic thickeners (polyethylene oxide and derived copolymers, xanthan gum, hydroxyethyl cellulose, acrylic or cationic polymers, etc.) or mineral thickeners (laponite), antioxidants, and pH-controlling agents, siliceous or non-siliceous mineral materials, especially reinforcing materials, bulking materials or materials having specific properties.

A pH-controlling agent used in the emulsion makes it possible to maintain the pH at alkaline values, for example between 7 and 8. This system for maintaining the pH may be, for example, sodium bicarbonate.

Optionally, the emulsion may additionally contain reinforcing or bulking mineral fillers, which are preferably chosen from pyrogenic silicas and precipitated silicas. They have a specific surface area, measured according to the BET methods, of at least 50 m²/g, especially between 50 and 400 m²/g, preferably greater than 70 m²/g, an average size of the primary particles of less than 0.1 micron (μm) and a bulk density of less than 200 g/l.

These hydrophilic silicas are preferably incorporated as is into the aqueous (continuous) phase of the emulsion. According to one variant, these silicas may optionally be treated by one or some organosilica compounds commonly used for this purpose. According to another variant, the silicas may be predispersed in the silicone oil. Figuring among these compounds are methylpolysiloxanes such as hexamethyldisiloxane, oxamethylcyclotetrasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane. During this treatment, the silicas may increase their starting weight by up to a factor of 20%.

It is generally possible to use from 0.5 up to 60 wt %, preferably from 10 to 25 wt % of filler, relative to the weight of the silicone phase of the formula.

The composition of the silicone emulsion may be, for example, the following:

A) a polydimethylsiloxane oil terminated at each of the chain ends by a (CH₃)₂ViSiO_{1/2} unit;
B) a poly(dimethyl)(hydromethyl) siloxane oil terminated at each of the chain ends by a (CH₃)₂HSiO_{1/2} unit;
C) at least one nonionic surfactant;
D) a platinum-based crosslinking catalyst;
E) from 20 to 80 wt % of calcium carbonate, relative to the dry weight of the outer layer after crosslinking that has a d₅₀ particle size between 1 and 10 μm;
F) water;
G) optionally a polyorganosiloxane resin, especially of MD^{Vi}Q type, optionally in solution in a polydimethyl-siloxane oil terminated at each of the chain ends by a (CH₃)₂ViSiO_{1/2} unit;
H) optionally at least one crosslinking inhibitor;
I) optionally at least one adhesion promoter chosen from the group comprising: at least one protective hydrocolloid, preferably polyvinyl alcohol, which may also act as a surfactant possibly in combination with other emulsifiers; specific silanes or polyorganosiloxanes, namely which are hydroxylated and amino-salified; a protective hydrocolloid, preferably polyvinyl alcohol, and hydroxylated and amino-salified silanes and/or polyorganosiloxanes; and
I) optionally at least one formulation additive.

The aqueous silicone emulsion according to the invention is of the type of that which can be crosslinked by polyaddition at ambient temperature (RTV), it being known that this platinum-catalyzed crosslinking may be activated at high temperature (100-200° C.).

This emulsion makes it possible to obtain fabrics coated with thin water-repellent layers of silicone elastomers that have good mechanical properties of suppleness, tear strength and resistance to fraying and that release little heat in the case of combustion.

The silicone phase of the emulsion according to the invention comprises POSs intended to generate the elastomer by crosslinking/curing at ambient temperature (23° C.) according to a polyaddition mechanism. It is possible to accelerate the crosslinking by thermal activation at a temperature above ambient temperature. Polyaddition room-temperature vulcanizable elastomers and polyaddition high-temperature vulcanizable elastomers come within the scope of the invention.

The aqueous emulsion may be produced at ambient temperature (25° C.) and at atmospheric pressure.

The aqueous emulsion of POS as defined above may be produced by forming an emulsion by introducing the constituents (A) to (J) into one and the same reactor.

It is also possible to produce this emulsion by mixing pre-emulsions which are each incapable of crosslinking separately due to the fact that they do not have all the reactive entities and the catalyst necessary for the polyaddition (in particular, POS ≡SiVi+POS≡SiH+catalyst).

For example, it is possible to produce an emulsion containing the ≡SiVi entities and the ≡SiH entities and optionally the inhibitor, and a catalyzing emulsion based on platinum and on ≡SiVi oil, which will be combined during the preparation of the coating bath. This greatly facilitates the production of a stable emulsion according to the invention which can be easily prepared under industrial conditions.

Thus, it is possible to produce the following pre-emulsions:
a pre-emulsion as a base of the POS (A);
a pre-emulsion as a base of the POS (B) (crosslinking emulsion); and/or
a pre-emulsion as a base of the catalyst (D) (catalyzing emulsion) composed, for example, of an aqueous emulsion of a platinum catalyst diluted in a vinyl-based silicone oil.

These pre-emulsions are then mixed. One or other of the previously mentioned pre-emulsions may additionally contain the surfactant (C), the fillers (E) and the other optional components (G)-(J).

The catalyzing emulsion may be added to the other silicone emulsions (especially that based on SiH) during the formulation of the bath, before application to the article.

The surfactant (C) may be put into emulsion via a direct route, i.e. the silicone phase is poured into the aqueous solution containing the surfactant, or vice versa.

The adhesion promoter (I) may be added at any time, especially during preparation of the bath.

The inner layer (1) in contact with the fibrous support is based on a silicone elastomer composition. Various types of these compositions may be used.

It is possible to use a wide variety of multicomponent, two-component or one-component organopolysiloxane compositions that crosslink at ambient temperature or at high temperature via, in particular, polyaddition, hydrosilylation or radical reactions to produce an elastomer. As a polyaddition reaction, mention may especially be made of the reaction of hydrosilyl groups with alkenylsilyl groups, generally in the presence of a metal catalyst, preferably a platinum catalyst (see, for example, U.S. Pat. Nos. 3,220,972, 3,284,406, 3,436,366, 3,697,473 and 4,340,709).

Mention may especially be made of a silicone elastomer composition obtained by crosslinking a polyorganosiloxane mixture capable of crosslinking via polyaddition reactions comprising at least:
one polyorganosiloxane having, per molecule, at least two C₂-C₆ alkenyl groups bonded to the silicon;
one polyorganosiloxane having, per molecule, at least two hydrogen atoms bonded to the silicon; and
in the presence of an effective amount of platinum-based crosslinking catalyst.

These polyorganosiloxanes may be the same as those described previously for the outer layer (2). The composition may also comprise various additives used for the formation of the outer layer (2).

The silicone elastomer composition preferably comprises reinforcing fillers, such as those described previously, especially polyorganosiloxane resins, and/or silica that has preferably been treated, more preferably in proportions between 5 and 50% of the inner layer.

Another subject of the present invention is a process for coating a fibrous support, in which:
deposited on the surface of a fibrous support is a silicone elastomer composition that can be crosslinked by polyaddition, hydrosilylation or radical reactions; and it is optionally crosslinked to form the inner layer (1), especially by drying; and
deposited on the inner layer (1) is the aqueous emulsion of a polyorganosiloxane that can be crosslinked by polyaddition reaction defined previously, and it is crosslinked so as to form the outer layer (2), especially by drying, so that said outer layer has a surface density between 1 and 20 g/m².

The deposition steps are advantageously carried out by coating. The coating step may especially be carried out using a knife, in particular a knife-over-roll, a floating knife or a knife-over-blanket, by transfer, by padding, that is to say by squeezing between two rolls, or else by lick roll, rotary machine, reverse roll, and/or spraying. For application of the outer layer an engraved roll or a transfer roll are particularly useful.

Next the drying and crosslinking are carried out, preferably by hot air or electromagnetic radiation, for example infrared radiation, especially for 10 seconds to 5 minutes, preferably from 10 to 60 seconds, at a crosslinking temperature without exceeding the degradation temperature of the fibrous support.

It should be noted that it is possible to crosslink or not to crosslink the composition applied to form the inner layer (1) before depositing the composition for the outer layer (2). In the case where the composition applied to form the inner layer (1) is not crosslinked, its crosslinking will be carried out when the crosslinking of the composition for forming the outer layer (2) is carried out.

The amount of silicone elastomer composition applied is such that it enables the formation of an inner layer (1) having a surface density between 10 and 200 g/m², preferably between 40 and 120 g/m². Generally, a final deposited thickness after crosslinking between 30 and 70 μm will be aimed for.

The amount of aqueous emulsion of a polyorganosiloxane that can be crosslinked by polyaddition reaction applied is such that it allows the formation of an outer layer (2) having a surface density between 1 and 20 g/m², preferably between 5 and 15 g/m². Generally, a final deposited thickness after crosslinking between 1 and 15 μm, preferably between 2 and 10 μm, more preferably still between 3 and 9 μm, especially 4, 5, 6 and 7 μm will be aimed for.

In the context of one-piece woven airbags, the silicone coating that is the subject of the invention is formed on the outer surface of said airbag, in contact with the user or the various vehicle components.

A specific language is used in the description so as to facilitate the understanding of the principle of the invention. It should nevertheless be understood that no limitation to the scope of the invention is envisaged by the use of this specific language. Modifications, improvements and perfections may especially be envisaged by a person skilled in the art in question on the basis of his own general knowledge.

The term “and/or” includes the meanings “and”, “or”, and also all the other possible combinations of the elements connected to this term.

Other details or advantages of the invention will appear more clearly in light of the examples given below solely by way of indication.

### EXPERIMENTAL SECTION

In these examples, the viscosity was measured using a Brookfield viscometer according to the instructions from the AFNOR NFT-76-106 standard from May 1982.

In the following examples, the components defined below were used:
POS A: polydimethylsiloxane oil terminated at each of the chain ends by a (CH₃)₂ViSiO_{1/2} unit, having a viscosity of 60 000 mPa·s.
POS B: poly(dimethyl)(hydromethyl)siloxane oil terminated at each of the chain ends by a (CH₃)₂HSiO_{1/2} unit, having a viscosity of 25 mPa·s and containing in total 0.7 Si—H functional groups per 100 g of oil (of which 0.6 Si—H functional groups are located in the chain).
resin G: MD^{Vi}Q resin in solution in a polydimethyl-siloxane oil terminated at each of the chain ends by a (CH₃)₂ViSiO_{1/2} unit, having a viscosity of 60 000 mPa·s, comprising 0.7 wt % of vinyls.
catalyst (D): platinum metal, introduced in the form of an organometallic complex containing 10 wt % of platinum metal, known under the name of Karstedt's catalyst.
inhibitor (H): 1-ethynylcyclohexanol (ECH).
Surfactant (C) 1: aqueous solution containing 10% of polyvinyl alcohol 25/140 (viscosity in solution at 4%/ester value) of RHODOVIOL® trademark. This solution also acts as an adhesion promoter (I).
Surfactant (C) 2: polyalkylene oxide-modified hepta-methyltrisiloxane.
Filler (E): calcium carbonate, reference ALBACAR© 5970, that has not been the subject of a compatibilization treatment (heating or surface functionalization), having a d₅₀ particle size of 2 μm.

### Example 1

### Preparation of Crosslinking Emulsions R

Mentioned in table 1 are the various weight compositions of the crosslinking emulsion (in g):

TABLE 1

| | CR1 | CR2 | R3 | R4 | R5 |
|---|---|---|---|---|---|
| POS A | 27 | 27 | 27 | 27 | 27 |
| Resin G | 27 | 27 | 27 | 27 | 27 |
| POS B | 2.5 | 2.5 | 2.5 | 2.5 | 2.5 |
| ECH | 0.06 | 0.06 | 0.06 | 0.06 | 0.06 |
| Surfactant 1 | 15 | 15 | 15 | 15 | 15 |
| Surfactant 2 | 0 | 2 | 2 | 2 | 2 |
| Filler (E) | 0 | 0 | 50 | 25 | 75 |
| Sorbic acid | 0.02 | 0.02 | 0.02 | 0.02 | 0.02 |
| Water | 28 | 28 | 28 | 28 | 28 |

CR1 and CR2 are comparative compositions.

CR1 and CR2 are comparative compositions.

Surfactant 1 and sorbic acid were introduced into an IKA laboratory reactor, equipped with a scraping anchor stirrer and a base (cooled by circulation of cold water). Then the resin G was poured in, with stirring, over 170 min. Next, POS A in which the ECH had been predispersed was poured in over 150 min. Then an ultra-turrax (IKA) rotor-stator was added and the emulsion was sheared over 90 min, 20 min at 16 000 rpm then 70 min at 13 000 rpm. The final temperature was 28.6° C. The average particle size was 3 microns. Next, POS B was poured in over 20 min. The emulsion was then diluted by gradual addition of demineralized water over 60 min.

Next, surfactant 2, then the filler (E) were added and were stirred up to homogenize them.

### Example 2

### Preparation of the Catalyzing Emulsion C

This emulsion comprised 53 wt % of POS A, 28 wt % of surfactant 1, 0.45 wt % of catalyst and 17.5 wt % of water.

### Example 3

### Preparation of Coated Woven Fabrics

The woven fabric was a warp and weft polyamide fabric of 470 dtex, having 18 yarns per centimeter. It was coated with an inner layer (1) of RHODORSIL TCS 7510 silicone from Rhodia Silicones having a surface density of 65 g/m². The inner layer (1) had a thickness of 60 μm.

Mixing of the amounts of crosslinking and catalyzing preparations indicated in table 2, optionally plus dilution water to adjust the viscosity and the concentration of the bath with a view to controlling the amount of silicone deposited on the woven fabric, was carried out during the formation of the coating bath, before application to the woven fabric.

The coating bath was applied to the fabric that had already been coated by the inner layer of silicone with a number 3 Meyer bar. Next, the coated woven fabric was passed into a ventilated heating chamber according to the conditions specified in table 2.

### Characterization of the Coated Woven Fabrics

Wetting: It was first assessed visually whether the emulsion applied for the outer layer of silicone had spread well over the inner layer of silicone. The formation of a uniform film of silicone led to the comment “OK”.
Deposition: The woven fabrics were weighed before coating, then after drying of the outer layer of silicone to assess the weight of the deposited outer layer.
Average thickness of the outer layer (2): The coated woven fabrics were cut crosswise and the cross section obtained was observed using a scanning electron microscope.
Dynamic coefficients of friction Kd: They were measured using a universal test machine used for tensile tests, the crosshead of which pulled a 200 g sled over a horizontal plane covered with a chamois material or with a clean glass sheet. The sled was fitted with the sample of coated woven fabric to be tested, silicone face on the side of the horizontal plane coated with the chamois material or glass sheet. The Kd demonstrated the ability of the sample to slide over the proposed surface. The lower the value obtained was, the lower the force required to make the material slide was.
Scrub test: This test of resistance to creasing and abrasion (ISO 5981 A standard) reflected the adhesion and the aging resistance of the composition. This test consisted in subjecting the woven fabric, on the one hand, to a shearing movement using two jaws gripping the two opposite ends of a test piece and moved back and forth one with respect to the other and, on the other hand, to an abrasion by contact with a movable support. As unit, the creasing (1 creasing=½ cycle) was used.

TABLE 2

| | | | | | | Proportion | | Immediate | | | |
|---|---|---|---|---|---|---|---|---|---|---|---|
| | Emulsion | Emulsion | Dilution | Cross- | | of fillers (E) | Thickness | wetting | | | Scrub |
| | R | C | water | linking | Depositions | in layer (2) | of layer (2) | observation | Kd | Kd | test |
| | g | G | g | ° C./min | g/m² | wt % | μm | uniform film | chamois | glass | cr. |
| C0 | 0 | 0 | 0 | — | | 0 | 0 | — | 3 | 1.5 | >1000 |
| C1 | 100 g CR1 | 10 | 0 | 120/2 | 7 | 0 | 7 | Not OK | 3 | 2 | — |
| C2 | 102 g CR2 | 10 | 0 | 120/2 | 10 | 0 | 10 | Not OK | — | — | — |
| 3 | 152 g R3 | 10 | 0 | 120/2 | 20 | 43.2 | 11.5 | OK | 0.5 | — | — |
| 4 | 152 g R3 | 10 | 0 | 120/2 | 10 | 43.3 | 5.8 | OK | 0.7 | — | >1000 |
| 5 | 177 g R4 | 5 | 50 | 180/1 | 5 | 44.3 | 3.4 | OK | 0.8 | 0.8 | >1000 |
| 6 | 202 g R3 | 5 | 50 | 180/1 | 8 | 28.4 | 4.6 | OK | 0.9 | 0.4 | >1000 |
| 7 | 227 g R5 | 3 | 50 | 180/1 | 8 | 54.8 | 4.1 | OK | 0.8 | 0.6 | >1000 |

C0, C1 and C2 are comparative examples.

### Example 4

### Coating of a One-Piece Woven Fabric and Measurement of the Gastightness

A sample of one-piece woven fabric (commonly known as “T-bag”) was firstly coated with an inner layer (1) of liquid silicone elastomer. Then an outer layer of emulsion was subsequently applied.

The coating of the inner layer (1) was carried out on a laboratory continuous coating pilot line (Rotary) using a knife at 2 m/min, followed by passing in-line into an oven at 180° C. The surface density of the inner layer (1) deposited was 60 g/m² on each face.

An emulsion comprising 100 g of emulsion R5, 5 g of emulsion C and 50 g of water was then applied on the same line using an engraved roll immersed in a bath of emulsion, the woven fabric then being wiped by a Meyer bar. The coating was carried out at 4 m/min and after passing into an oven at 170° C. an outer layer (2) was obtained having a surface density of 10 g/m².

These coated bags were subjected to a dynamic permeability test. During this test, a previously pressurized sealed chamber was instantaneously brought into contact with the inside of the bag via a solenoid valve. At this instant there was a pressure of 1 bar in the reservoir and the silicone-coated one-piece woven bag. The system was then isolated, it only being possible for leaks to occur through the coated surface of the bag. The gastightness was characterized by the time taken for the pressure to decrease from 1 bar to 1.5 bar. This test is particularly aggressive due to the fact that the sudden pressurization of the bag and the pressure used are greater than in the usual permeability tests.

5 seconds were needed for the bag solely comprising the inner layer (1) coating. A contrario, 18 seconds were required for the bag comprising the inner layer (1) and the outer layer (2).

1. An article comprising at least one fibrous support surface coated by at least two successive layers of silicone type:
an inner layer, in contact with the fibrous support, based on a silicone elastomer composition; and
an outer layer, having a surface density between 1 and 20 g/m², in contact with the inner layer, obtained by crosslinking an aqueous emulsion of a polyorganosiloxane that can be crosslinked by polyaddition reaction, comprising:
(A) at least one polyorganosiloxane having, per molecule, at least two unsaturated functional groups of C₂-C₆ alkenyl type, bonded to the silicon;
(B) at least one polyorganosiloxane having, per molecule, at least two hydrogen atoms bonded to the silicon;
(C) at least one surfactant;
(D) at least one crosslinking catalyst;
(E) at least 10 to 80 wt % of a filler, relative to the dry weight of the outer layer after crosslinking, said filler has a d₅₀ particle size between 0.5 and 50 μm; and
(F) water;
(G) optionally at least one polyorganosiloxane resin optionally comprising at least one alkenyl group;
(H) optionally at least one crosslinking inhibitor;
(I) optionally at least one adhesion promoter; and
(J) optionally at least one formulation additive.

2. The article as claimed in claim 1, wherein the crosslinking catalyst comprises of at least one metal, or compound, from the platinum group.

3. The article as claimed in claim 1, wherein the filler is selected from the group consisting of silicas, calcium carbonate, ground quartz, calcined clays, diatomaceous earths, carbon black, titanium dioxide, aluminum oxide, hydrated alumina, expanded vermiculite, unexpanded vermiculite, zinc oxide, mica, talc, iron oxide, barium sulfate and flaked lime.

4. The article as claimed claim 1, wherein the aqueous silicone emulsion comprises from 30 to 50% of filler, relative to the dry weight of the outer layer after crosslinking.

5. The article as claimed in claim 1, wherein the filler has a d₅₀ particle size between 1 and 10 μm.

6. The article as claimed in claim 1, wherein the aqueous emulsion comprises at least one nonionic surfactant.

7. The article as claimed in claim 1, wherein the aqueous emulsion comprises at least one nonionic surfactant from the group consisting of: alkoxylated fatty acids, polyvinyl alcohols, polyalkoxylated alkylphenols, polyalkoxylated fatty alcohols, polyalkoxylated or polyglycerolated fatty amides, polyglycerolated alcohols and α-diols, ethylene oxide/propylene oxide block polymers, alkyl glucosides, alkyl polyglucosides, sucrose ethers, sucrose esters, sucroglycerides, sorbitan esters, and ethoxylated compounds of these sugar derivatives.

8. The article as claimed in claim 1, wherein the composition of the silicone emulsion comprises:
A) a polydimethylsiloxane oil terminated at each of the chain ends by a (CH₃)₂ViSiO_{1/2} unit;
B) a poly(dimethyl)(hydromethyl)siloxane oil terminated at each of the chain ends by a (CH₃)₂HSiO_{1/2} unit;
C) at least one nonionic surfactant;
D) a platinum-based crosslinking catalyst;
E) from 10 to 80 wt % of calcium carbonate, relative to the dry weight of the outer layer after crosslinking that has a d₅₀ particle size between 1 and 10 μm;
F) water;
G) optionally a polyorganosiloxane resin, especially of MD^{Vi}Q type, optionally in solution in a polydimethylsiloxane oil terminated at each of the chain ends by a (CH₃)₂ViSiO_{1/2} unit;
H) optionally at least one crosslinking inhibitor;
I) optionally at least one adhesion promoter chosen from the group comprising: at least one protective hydrocolloid, preferably polyvinyl alcohol, which may also act as a surfactant possibly in combination with other emulsifiers; specific silanes or polyorganosiloxanes, namely which are hydroxylated and amino-salified; a protective hydrocolloid, preferably polyvinyl alcohol, and hydroxylated and amino-salified silanes and/or polyorganosiloxanes; and
J) optionally at least one formulation additive.

9. The article as claimed in claim 1, wherein the aqueous emulsion forming the outer layer is a multicomponent, two-component or one-component polyorganosiloxane composition that crosslinks at ambient temperature or at high temperature via polyaddition reactions to produce an elastomer.

10. The article as claimed in claim 1, wherein the silicone elastomer composition of the inner layer is a multicomponent, two-component or one-component organopolysiloxane composition that crosslinks at ambient temperature or at high temperature via polyaddition, hydrosilylation or radical reactions to produce an elastomer.

11. The article as claimed in claim 1, wherein the inner layer has a surface density between 10 and 200 g/m².

12. The article as claimed in claim 1, wherein the inner layer has a thickness, after crosslinking, between 30 and 70 μm.

13. The article as claimed in claim 1, wherein the outer layer has a surface density between 5 and 15 g/m².

14. The article as claimed in claim 1, wherein the outer layer has a thickness, after crosslinking, between 1 and 15 μm.

15. The article as claimed in claim 1, wherein the fibrous support is chosen from the group comprising: airbags used for protecting the occupants of a vehicle, glass braids, conveyor belts, fire-resistant fabrics, thermal insulation, compensators, clothing, flexible materials intended to be used in interior or exterior textile architecture.

16. The article as claimed in claim 1, wherein the fibrous support is a one-piece woven airbag for protecting the occupants of a vehicle; and that the silicone coating made up of the layers and is located on the outer surface of said airbag, in contact with the user or the various components of the vehicle.

17. A process for coating a fibrous support in order to obtain an article as claimed in claim 1, in which:
deposited on the surface of a fibrous support is a silicone elastomer composition that can be crosslinked by polyaddition, hydrosilylation or radical reactions; and it is optionally crosslinked to form the inner layer, especially by drying; and
deposited on the inner layer is the aqueous emulsion of a polyorganosiloxane that can be crosslinked by polyaddition reaction defined previously, and it is crosslinked so as to form the outer layer, especially by drying, so that said outer layer has a weight between 1 and 20 g/m².

18. The process as claimed in claim 17, wherein the depositions of layers are carried out by coating.

19. The process as claimed in claim 17, wherein the drying is carried out by hot air or electromagnetic radiation.
